(19) United States
(12) Patent Application Publication
(10) Pub. No.: US 2003/0133601 A1
(43) Pub. Date: Jul. 17, 2003

(54) Automated method and system for the differentiation of bone disease on radiographic images

(75) Inventors: Maryellen L. Giger, Elmhurst, IL (US); Michael R. Chinander, Chicago, IL (US); Tamara Vokes, Chicago, IL (US); Murray Favus, Chicago, IL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: University of Chicago, Chicago, IL

(21) Appl. No.: 10/301,836

(22) Filed: Nov. 22, 2002

Related U.S. Application Data
(60) Provisional application No. 60/331,995, filed on Nov. 23, 2001.

(51) Int. Cl. G06K 9/00; G06K 9/36

(52) U.S. Cl. 382/128; 382/280

(57) ABSTRACT

A method, system, and computer program product for analyzing a medical image to determine a measure of bone strength, comprising identifying plural regions of interest (ROIs) in the medical image; calculating at least one texture feature value for each ROI; averaging the at least one texture feature value calculated for each ROI to obtain at least one average texture feature value; and determining the measure of bone strength based on the at least one average texture feature value using a classifier. Alternatively, the image data in each ROI is first transformed into the frequency domain and averaged to obtain an average image. This process reduces noise and improves the performance of the system. The assessment of bone strength and/or osteoporosis is used as a predictor of risk of fracture.

### CROSS-REFERENCE TO CO-PENDING APPLICATIONS

The present application is related to and claims priority to U.S. Provisional Application Serial No. 60/331,995, filed Nov. 23, 2001. The contents of that application are incorporated herein by reference.

The present invention was made in part with U.S. Government support under grant number ROI AR42739 from the National Institute of Health. The U.S. Government may have certain rights to this invention.

### BACKGROUND OF THE INVENTION

1. Field of the Invention

The invention relates generally to a method and system for the computerized diagnosis of bone disease on radiographic images.

The present invention also generally relates to computerized techniques for automated analysis of digital images, for example, as disclosed in one or more of U.S. Pat. Nos. 4,839,807; 4,841,555; 4,851,984; 4,875,165; 4,907,156; 4,918,534; 5,072,384; 5,133,020; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,732,697; 5,740,268; 5,790,690; 5,832,103; 5,873,824; 5,881,124; 5,931,780; 5,974,165; 5,982,915; 5,984,870; 5,987,345; 6,011,862; 6,058,322; 6,067,373; 6,075,878; 6,078,680; 6,088,473; 6,112,112; 6,138,045; 6,141,437; 6,185,320; 6,205,348; 6,240,201; 6,282,305; 6,282,307; 6,317,617; 6,335,980, 6,363,163; 6,442,287, 6,466,689; 6,470,092; 6,483,934 as well as U.S. patent application Ser. Nos. 09/692,218; 09/759,333; 09/760,854; 09/773,636; 09/816,217; 09/830,562; 09/818,831; 09/860,574; 10/270,674; 10,292,625; No. 60/395,305; and co-pending application Ser. Nos. 09/990,311 and 09/990,310; and PCT patent applications PCT/US00/41299; PCT/US01/00680; PCT/US01/01478 and PCT/US01/01479, all of which are incorporated herein by reference.

The present invention includes use of various technologies referenced and described in the above-noted U.S. patents and applications, as well as described in the references identified in the following LIST OF REFERENCES by the author(s) and year of publication and cross referenced throughout the specification by reference to the respective number, in parenthesis, of the reference:

### LIST OF REFERENCES

1. Beck, T. J., Ruff, C. B., Warden, K. E., Scott, W. W. and Rao, G. U. Predicting femoral neck strength from bone mineral data, a structural approach. Investigative Radiology 25:6-18; 1989.

2. Cann, C. E., Genant, H. K., Kolb, F. O. and Ettinger, B. Quantitative computed tomography for the prediction of vertebral body fracture risk. Bone 6:1-7; 1985.

3. Carter, D. and Haye, W. The compressive behavior of bone as a two-phase porous structure. J. Bone Joint Surg. 59A:954-962; 1977.

4. Carter, D. R., Bouxsein, M. L. and Marcus, R. New approaches for interpreting projected bone densitometry data. J. Bone Miner. Res. 7:137-145; 1992.

5. Faulkner, K. T., McClung P. and Cummings S. E. Automated evaluation of hip axis length of predicting hip fracture. J. Bone Miner. res. 9:1065-1070; 1994.

6. Grampp, S., Genant, H. K., Mathur, A., Lang, P., Jergas, M., Takada, M., Gluer C. C., Lu, Y. and Chavez, M. Comparison of noninvasive bone mineral measurements in assessing age-related loss, fracture discrimination, and diagnostic classification. J. Bone Miner. Res. 12: 697-711; 1997.

7. Karlsson, K. M., Sembo, I., Obrant, K. J., Redlund-Johnell, I. and Johnell, O. Femoral neck geometry and radiographic signs of osteoporosis as predictors of hip fracture. Bone 18:327-330; 1996.

8. Keaveny, T. M. and Hayes, W. C. A 20-year perspective on the mechanical properties of trabecular bone, Trans. of ASME 115: 534 542; 1993.

9. Lang, T. F. Summary of research issues in imaging and noninvasive bone measurement. Bone 22:159S-160S; 1998.

10. Martin, R. and Burr, D. Non-invasive measurement of long bone cross-sectional moment of inertia by photon absorptiometry. J. Biomech. 17:195-201; 1984.

11. McBroom, R., Hayes, W., Edwards, W., Goldberg, R. and White, A. Prediction of vertebral body compressive fracture using quantitative computed tomography. J. Bone Joint Surg. 67A:1206-1214; 1985.

12. Nielsen, H., Mosekilde, L., Melsen, B., Christensen, P. and Melsen, F. Relations of bone mineral content, ash weight and bone mass: implications for correction of bone mineral content for bone size. Clin. Orthop. 153: 241-247; 1980.

13. Ross, P. D., Davis, J. W., Vogel J. M. and Wasnich R. D. A critical review of bone mass and the risk of fracture in osteoporosis. Calcif. Tissue Int. 46:149-161; 1990.

14. Sartoris, D. J. and Resnick, D. Current and innovation methods for noninvasive bone densitometry. Radiologic Clinics of North America 28:257-278; 1990.

15. Seeman, E. Editorial: Growth in bone mass and size are racial and gender differences in bone mineral density more apparent than real? J. Clin. Endocrinol. Metab. 83:1414-1419; 1998.

16. Sieranen, H., Kannus, P., Oja, P. and Vuori, I. Dual-energy X-ray absorptiometry is also an accurate and precise method to measure the dimensions of human long bones. Calcif. Tissue Int. 54: 101-105; 1994.

17. R. S. A. Acharya, A. LeBlanc, L. Shackelford, V. Swamarkar, R. Krishnamurthy, E. Hausman and C. Lin, “Fractal analysis of bone structure with application to osteoporosis and microgravity effects,” SPIE 2433, 388-403 (1995).

18. C. L. Benhamou, E. Lespessailles, G. Jacquet, R. Harba, R. Jennane, T. Loussot, D. Tourliere and W. Ohley, “Fractal organization of trabecular bone images on calcaneus radiographs,” J. Bone and mineral research 9, 1909-1918 (1994).

19. S. M. Bentzen, I. Hvid and J. Jorgensen, “Mechanical strength of tibial trabecular bone evaluation by x-ray computed tomography,” J. Biomech. 20, 743-752 (1987).

20. G. H. Brandenburger, “Clinical determination of bone quality: is ultrasound an answer,” Calcif. Tissue Int. 53, S151-S156 (1990).

21. P. Caligiuri, M. L. Giger, M. J. Favus, H. Jia, K. Doi, and L. B. Dixon, “Computerized radiographic analysis of osteoporosis: preliminary evaluation,” Radiology 186, 471-474 (1993).

22. D. A. Chakkalakl, L. Lippiello, R. F. Wilson, R. Shindell and J. F. Connolly, “Mineral and matrix contributions to rigidity in fracture healing,” J. Biomech. 23, 425-434 (1990).

23. S. C. Cowin, W. C. Van Buskirk and R. B. Ashman, “Properties of bone,” In Handbook of Bioengineering: edited by R. Skalak and S. Chien, 2.1-2.28, (McGraw-Hill, NY, 1987).

24. P. 1. Croucher, N. J. Garrahan and J. E. Compston, “Assessment of cancellous bone structure: comparison of strut analysis, trabecular bone pattern factor, and marrow space star volume,” J. Bone Miner. Res. 11, 955-961 (1996).

25. E. P. Durand and P. Ruegsegger, “High-contrast resolution of CT images for bone structure analysis,” Med. Phys. 19, 569-573 (1992).

26. J. C. Elliott, P. Anderson, R. Boakes and S. D. Dover, “Scanning X-ray microradiography and microtomography of calcified tissue,” In Calcified Tissue: edited by D. W. L. Hukins, (CRC Press, inc. Boca Raton, Fla., 1989).

27. K. G. Faulkner, C. Gluer, S. Majumdar, P. Lang, K. Engelke and H. K. Genant, “Noninvasive measurements of bone mass, structure, and strength: current methods and experimental techniques,” AJR 157, 1229-1237 (1991).

28. L. A. Feldkamp, S. A. Goldstein, A. M. Parfitt, G. Jesion, and M. Kleerekoper, “The direct examination of three-dimensional bone architecture in vitro by computed tomography,” J. Bone Miner. Res. 4, 3-11 (1989).

29. S. A. Goldstein, “The mechanical properties of trabecular bone: dependence on anatomical location and function,” J. Biomech. 20, 1055-1061 (1987).

30. R. W. Goulet, S. A. Goldstein, M. J. Ciarelli, J. L. Kuhn, M. B. Brown and L. A. Feldkamp, “The relationship between the structural and orthogonal compressive properties of trabecular bone,” J. Biomech. 27, 375-389 (1994).

31. I. Hvid, S. M. Bentzen, F. Linde, L. Mosekilde and B. Pongsoipetch, “X-ray quantitative computed tomography: the relations to physical properties of proximal tibial trabecular bone specimens,” J. Biomech. 22, 837-844 (1989).

32. C. Jiang, R. E. Pitt, J. E. A. Bertram, and D. J. Aneshansley, “Fractal-based image texture analysis of trabecular bone architecture,” Medical & Biological Engineering & Computing, Submitted (1998a).

33. C. Jiang, R. E. Pitt, J. E. A. Bertram, and D. J. Aneshansley, “Fractal characterization of trabecular bone structure and its relation to mechanical properties,” J. Biomech., Submitted (1998b).

34. S. Katsuragawa, K. Doi. and H. MacMahon, Image feature analysis and computer-aided diagnosis in digital radiograph: detection and characterization of interstitial lung disease in digital chest radiographs, Medical Physics 15:311-319 (1988).

35. T. M. Keaveny, E. F. Wachtel, C. M. Ford and W. C. Hayes, “Differences between the tensile and compressive strengths of bovine tibial trabecular bone depend on modulus,” J. Biomech. 27, 1137-1146 (1994).

36. S. Majumder, R. S. Weinstein and R. R. Prasad, “Application of fractal geometry techniques to the study of trabecular bone,” Med. Phys. 20, 1611-1619 (1993).

37. S. Majumder, M. Kothari, P. Augat, D. C. Newitt, T. M. Link, J. C. Lin, T. Lang, Y. Lu and H. K. Genant, “High-resolution magnetic resonance imaging: three-dimensional trabecular bone architecture and biomechanical properties,” Bone 55, 445-454 (1998).

38. B. B. Mandelbrot, The fractal geometry of nature, (Freeman, San Francisco, Calif., 1982).

39. P. Maragos, “Fractal signal analysis using mathematical morphology,” Advances in Electronics and Electron Physics 88, 199-246 (1994).

40. R. Martin and D. Burr, “Non-invasive measurement of long bone cross-sectional moment of inertia by photon absorptiometry,” J. Biomech. 17, 195-201 (1984).

41. J. Neter, W. Wasserman and M. H. Kuter, Applied linear statistical models (3rd edition), (Richard D. Irwin, Inc., 1990).

42. J. Serra, Image Analysis and Mathematical Morphology. (Academic, London, 1982).

43. W. J. Whitehouse, “The quantitative morphology of anisotropic trabecular bone,” J. Microsc. 101, 153-168 (1974).

44. Jiang C, Giger M L, Chinander M R, Martell J M, Kwak S, Favus M J: Characterization of bone quality using computer-extracted radiographic features. Medical Physics 26: 872-879, 1999.

45. Chinander M R, Giger M L, Martell J M, Favus M J: Computerized radiographic texture measures for characterizing bone strength: A simulated clinical setup using femoral neck specimens. Medical Physics 26: 2295-2300, 1999

46. Jiang C, Giger M L, Kwak S, Chinander M R, Martell J M, Favus M J: Normalized BMD as a predictor of bone strength. Academic Radiology 7: 33-39, 2000.

47. Chinander M R, Giger M L, Martell J M, Favus M J: Computerized analysis of radiographic bone patterns: Effect of imaging conditions on performance. Medical Physics 27: 75-85, 2000.

2. Discussion of the Background

Although there are many factors that affect bone quality, two primary determinants of bone mechanical properties are bone mineral density (BMD) and bone structure. Among the density and structural features extracted from bone using various techniques, researchers agree that BMD is the single most important predictor of bone strength as well as disease-conditions, such as osteoporosis. Studies have shown a correlation between BMD and bone strength (see references 1, 3, and 8). For this purpose, a range of techniques have been developed to measure BMD and to evaluate fracture risk, to diagnose osteoporosis, to monitor therapy of osteoporosis, and to predict bone strength (see references 3, 6 and 13).

The standard technique for noninvasive evaluation of bone mineral status is bone densitometry. Among various techniques for bone densitometric measurement, dual energy X-ray absorptiometry (DXA) is relatively inexpensive, low in radiation dose (<5 FSv effective dose equivalent), and of high accuracy (about 1%) and precision (about 1%) (see references 9, 14). DXA has gain widespread clinical acceptance for the routine diagnosis and monitoring of osteoporosis. In addition, DXA can be directly used to measure whole bone geometric features (see references 5, 7, 9, and 16). The BMD measurement from DXA, however, is only moderately correlated to bone mechanical properties, and has limited power in separating the patients with and without osteoporosis-associated fractures (see reference 2). DXA is an integral measure of cortical and trabecular bone mineral content along the X-ray path for a given projected area and only measures bone mass, not bone structure. As a consequence, DXA measurements are bone-size dependent and yield only bone mineral density per unit area (g/cm²) instead of true density, i.e., volumetric bone mineral density (g/cm³). Therefore, if the BMD measurements of patients with different bone sizes are compared, the results can be misleading.

Although the effect of bone size on area BMD using DXA is apparent (see references 4 and 15), only a few studies (see references 3, 10, and 12) have been performed to account for such a bias. To compensate for the effect of bone size for vertebral bodies, researchers have developed an analysis method and suggested a new parameter, bone mineral apparent density (BMAD), as a measure of volumetric bone mineral density (see reference 4).

In clinical application, because of bone size variation, it is impossible to measure true volumetric BMD with DXA. Nevertheless, for the purpose of comparison of individuals with different bone sizes, it is possible to normalize the area-based BMD with a geometric dimension that is proportional to bone thickness in a noninvasive manner.

Also, one of the functions of bone is to resist mechanical failure such as fracture and permanent deformation. Therefore, biomechanical properties are fundamental measures of bone quality. The biomechanical properties of trabecular bone are primarily determined by its intrinsic material properties and the macroscopic structural properties (see references 8, 20, 23, and 22). Extensive efforts have been made to evaluate bone mechanical properties by studying bone mineral density (BMD) and mineral distribution.

Since bone structural rigidity is derived primarily from its mineral content (see reference 26), most evaluation methods have been developed to measure bone mass (mineral content or density) and to relate these measures to bone mechanical properties (see references 3, 8, 19, 31, and 35). Results from in vivo and in vitro studies suggest that BMD measurements are only moderately correlated to bone strength (see reference 4). However, studies have shown changes in bone mechanical properties and structure that are independent of bone mineral density (see references 27 and 29). Moreover, because density is an average measurement of bone mineral content within bone specimens, it does not include information about bone architecture or structure.

Various methods have been developed for in vitro study of the two- or three-dimensional architecture of trabecular bones using histological and stereological analyses (see references 28, 29, 30, and 43). These studies have shown that, by combining structural features with bone density, 72 to 94 percent of the variability in mechanically measured Young's moduli could be explained. However, these measurements are invasive.

For the noninvasive examination of trabecular bone structure, investigators have developed high-resolution computed tomography (CT) and magnetic resonance imaging (MRI) (see references 25, 28, and 36). However, due to cost and/or other technical difficulties, these techniques are currently not in routine clinical use. The potential use of X-ray radiographs to characterize trabecular bone structure has also been studied. Although the appearance of trabecular structure on a radiograph is very complex, studies have suggested that fractal analysis may yield a sensitive descriptor to characterize trabecular structure from x-ray radiographs both in in vitro studies (see references 18, 39 and 44) and in an in vivo study (see reference 34).

Different methods, however, exist with which to compute fractal dimension. Minkowski dimension, a class of fractal dimension that is identical to Hausdroff dimension (see reference 38), is particularly suitable for analyzing the complex texture of digital images because it can be formally defined through mathematical morphology, and easily computed using morphological operations (see references 39 and 42). The Minkowski dimension computed from an image, regardless of texture orientation, gives a global dimension that characterizes the overall roughness of image texture. Similarly, the Minkowski dimensions computed from different orientations yield directional dimensions that can be used to characterize the textural anisotropy of an image (see reference 33).

Studies have also been performed demonstrating the important contributions of normalized BMD, structural features, and age to bone mechanical properties, i.e., bone strength (see references 45, 46, and 47). In addition, the limitation of fractal-based analyses was shown to be overcome with the use of an artificial neural network (ANN) to extract fractal information.

### SUMMARY OF THE INVENTION

Accordingly, an object of the present invention is to provide a method, system, and computer program product for the analysis of bone mass, strength, and structure.

Another object of this invention is to perform texture analysis using the trabecular mass and bone pattern from digital radiographic images, obtained with a bone densitometer, for the assessment of bone strength and/or osteoporosis and as an indicator or predictor of bone disease.

Yet another object of this invention is to perform analysis of regions within the oscalcsis analysis of the trabecular mass and bone pattern for the assessment of bone strength and/or steoporosis and for an indicator or predictor of bone disease.

These and other objects are achieved by way of a method, system, and computer program product for analyzing a medical image to determine a measure of bone strength, comprising: (1) identifying plural regions of interest (ROIs) in the medical image; (2) calculating at least one texture feature value for each ROI; (3) averaging the at least one texture feature value calculated for each ROI to obtain at least one average texture feature value; and (4) determining the measure of bone strength based on the at least one average texture feature value.

In addition, according to another aspect of the present invention, there is provided a novel method, system, and computer program product for analyzing a medical image to determine a measure of bone strength, comprising: (1) identifying plural regions of interest (ROIs) in the medical image; (2) transforming image data in each of said ROIs into respective frequency domain image data; (3) averaging the respective frequency domain image data to obtain average image data; (4) calculating at least one texture feature value from the average image data; and (5) determining the measure of bone strength based on the at least one texture feature value.

In addition, according to still another aspect of the present invention, there is provided a novel method, system, and computer program product for analyzing plural medical images to determine a measure of bone strength, comprising: (1) identifying a region of interest (ROI) having a corresponding center pixel in each medical image; (2) transforming image data in the ROI of each medical image into respective frequency domain image data; (3) averaging the respective frequency domain image data to obtain an average image; (4) calculating at least one texture feature value from the average image; and (5) determining the measure of bone strength based on the at least one texture feature value.

In addition, according to still another aspect of the present invention, there is provided a novel method, system, and computer program product for analyzing a medical image to determine a measure of bone strength, comprising: (1) identifying plural regions of interest (ROIs) in the medical image, each ROI having a corresponding center pixel; (2) transforming image data in each of said ROIs into respective frequency domain image data; (3) calculating at least one texture feature value for each ROI using the respective frequency domain image data; and (4) determining the measure of bone strength based on the at least one texture feature value.

In addition, according to still another aspect of the present invention, there is provided a novel method, system, and computer program product for analyzing plural medical images to form at least one texture feature image, comprising: (1) identifying a region of interest (ROI) having a corresponding center pixel in each medical image; (2) calculating at least one texture feature value for the ROI in each medical image; (3) averaging the at least one texture feature value of each medical image in the plural medical images; (4) repeating the identifying, calculating, and averaging steps for a plurality of ROIs having a corresponding plurality of center pixels; (5) associating the at least one feature value calculated in each calculating step with a center pixel in the corresponding plurality of center pixels to form the at least one texture feature image.

In addition, an aspect of the present invention is the use of area-based BMD and volumetric BMD as predictors of bone mechanical properties, and a procedure for non-invasively normalizing BMD values for use in clinical applications.

A further aspect of the present invention is the use of an estimate of risk of fracture, a reduction of noise in skeletal imaging of the trabecular pattern, and a visualization of texture feature images in assessing bone strength.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A more complete appreciation of the invention and many of the attendant advantages thereof will be readily obtained as the same becomes better understood by reference to the following detailed description when considered in connection with the accompanying drawings, wherein:

FIG. 1a is a flowchart illustrating a method of analysis of bone structure from plural images according to the present invention;

FIG. 1b is a flowchart illustrating a method for analysis of bone structure from a single image according to the present invention;

FIG. 1c is a flowchart illustrating a second method for analysis of bone structure from a single image according to the present invention;

FIG. 1d is a flowchart illustrating a third method for analysis of bone structure from a single image according to the present invention;

FIG. 2 is an image illustrating a high resolution digital radiographic heel image (0.2 mm pixel size) from a commercial portable peripheral bone densitometer;

FIG. 3 is a graph illustrating a plot of the relationship between the first moment texture feature for the individual image and for the measure obtained from the average of five ROIs in the spatial frequency domain for cases in a first database (Database 1);

FIG. 4 is a graph illustrating a plot of the relationship between the first moment texture feature for the individual image and for the measure obtained from the average of two ROIs in the spatial frequency domain for cases in a second database (Database 2);

FIG. 5 is an image illustrating a first moment feature image for a heel for a case with a spine fracture;

FIG. 6 is an image illustrating a first moment feature image for the heel for a case without a spine fracture;

FIG. 7 is a block diagram illustrating a system for the analysis of bone mass and/or bone structure according to the present invention;

FIG. 8 is a flowchart illustrating a method for the calculation of a texture feature image using multiple image exposures;

FIG. 9 is a flowchart illustrating a second method for the calculation of a texture feature image using multiple image exposures; and

FIG. 10 is a flowchart illustrating a method for the calculation of a texture feature image using a single image exposure.

### DETAILED DESCRIPTION OF THE PREFERRED EMBODIMENTS

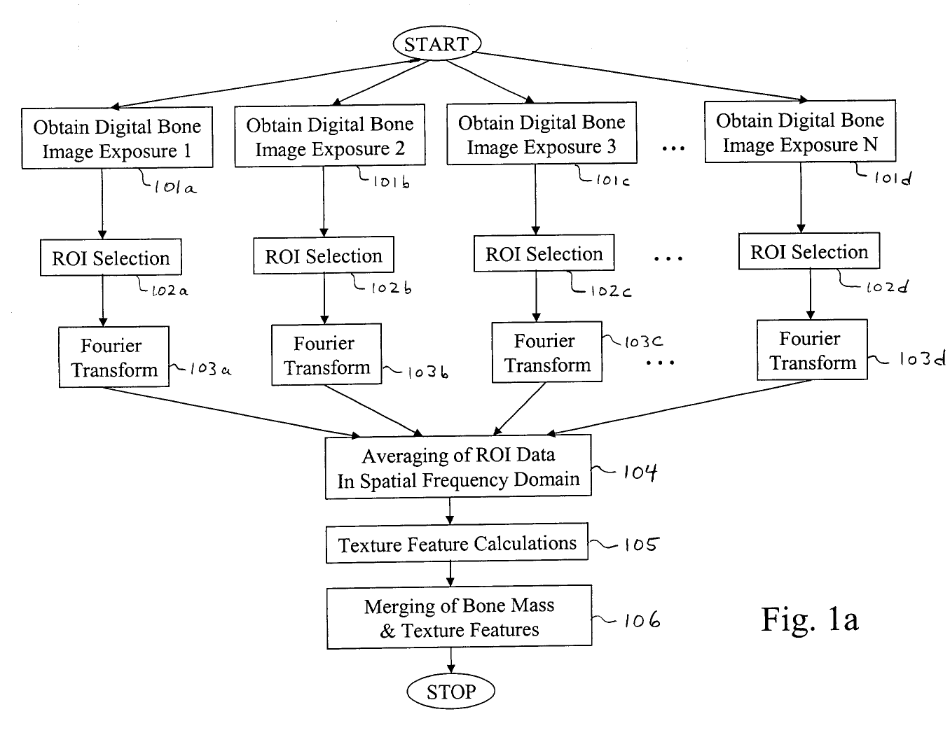

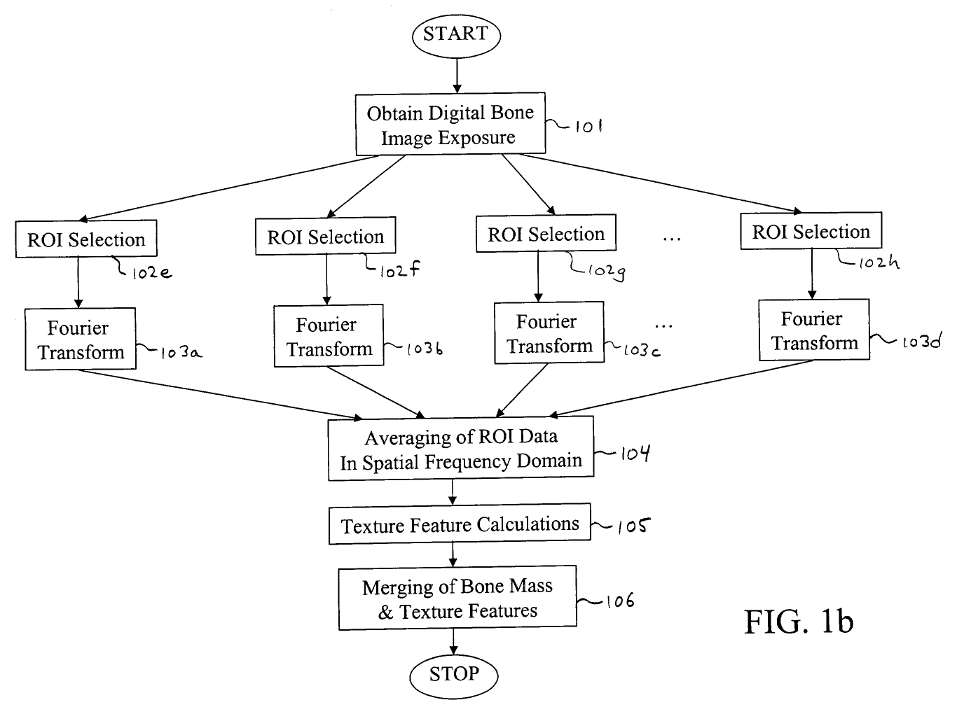

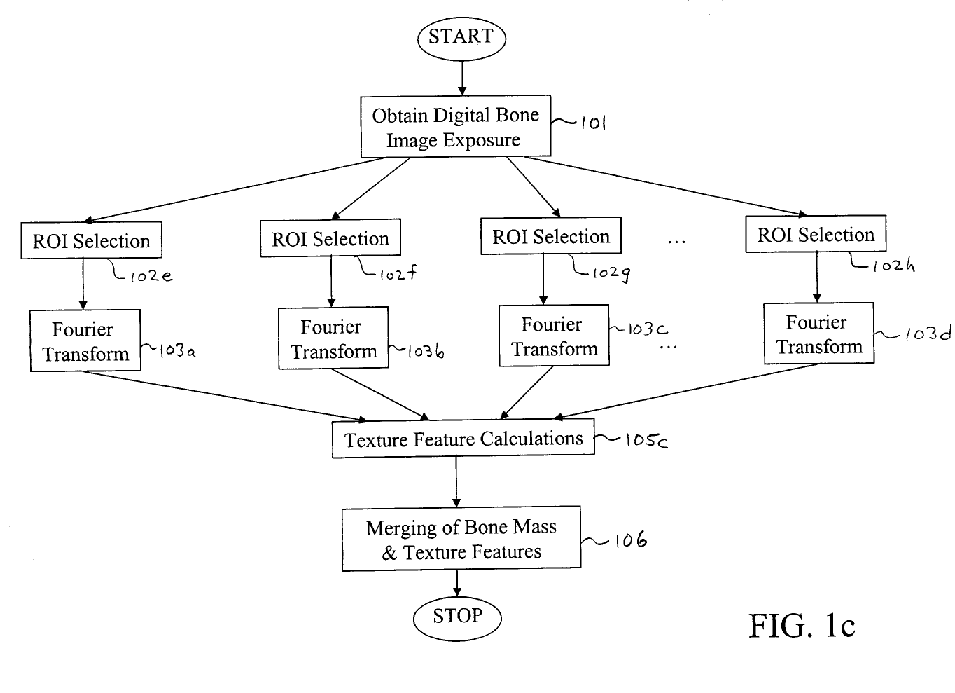

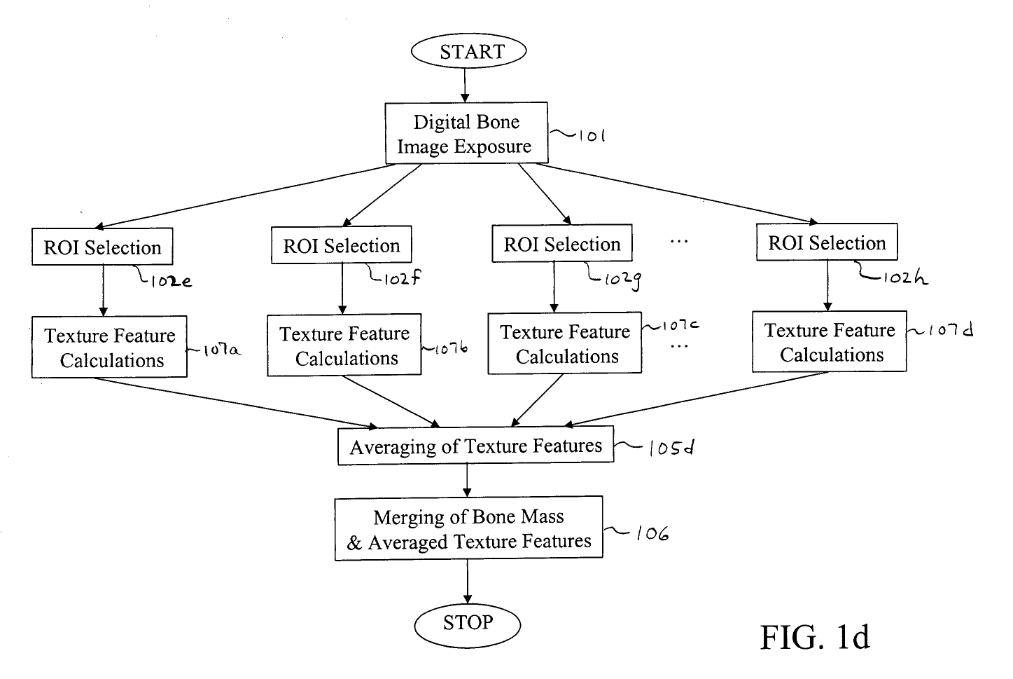

Referring now to the drawings, and more particularly to FIG. 1a thereof, a method for the analysis of bone is shown. In this example, the characteristics of the bone trabecular pattern using computer analysis of image data from digital images of bony parts of the body, for example, the heel are extracted. Although the heel is used as an example, it should be appreciated that alternate bony parts of the body may be used. Further, for the purposes of this description we shall define image to be a representation of a physical scene, in which the image has been generated by some imaging technology. Examples of imaging technology include television, CCD cameras, X-ray, sonar or ultrasound imaging devices, CT or MRI devices, etc. The initial medium on which an image is recorded could be an electronic solid-state device, a photographic film, or some other device such as a photostimulable phosphor. The recorded image may be then converted into digital form by a combination of electronic means (used for example with images from CCD signal) or mechanical/optical means (used for example with digitizing a photographic film or data from photostimulable phosphor). An image may have any number of dimensions including one (e.g. acoustic signals), two (e.g. X-ray radiological images) or more (e.g. nuclear magnetic resonance images).

The present invention is preferably computer implemented and can be configured to accept image data either from an image acquisition device directly from an image digitizer or from an image storage device. The image storage device may be local, e.g., associated with an image acquisition device or image digitizer, or may be remote so that upon being accessed for processing according to the present invention, the image data is transmitted via a network, for example a Picture Archiving Communications System (PACS) or other network.

With a continued reference to FIG. 1a, images, digital bone images are obtained in parallel steps 101a, 101b, 101c, and 101d. An exemplary bone image is a digital radiograph of the heel, for example.

Next, in parallel steps 102a, 102b, 102c, and 102d, regions of interest (ROIs) are obtained in each respective digital bone image obtained in steps 101a, 101b, 101c, and 101d. The image data corresponding to the ROIs may be stored in memory. Note that bone mineral densitometry (not shown) may be performed on the individual images of the bone and also stored in memory (not shown).

Next, in parallel steps 103a, 103b, 103c, and 103d, a two-dimensional discrete Fourier transform of the image data in the respective ROIs is calculated.

In step 104, the Fourier-transformed ROI image data is averaged, thus reducing noise.

Next, in step 105, texture feature calculations are performed on the averaged ROI data to produce characteristics of the bone texture. Various individual textures measures are calculated using texture schemes, e.g., texture measures requiring Fourier analysis. In addition, the Minkowski dimension and other appropriate texture measures can also be calculated.

Next, in step 106, bone texture feature values and feature-related data (e.g., bone mass) are merged. Other feature related data that may be merged with bone texture include bone geometry, bone structure, and clinical data, such as the age of the subject. Merging is performed by classifiers, such as, but not limited to, a linear discriminant and/or an artificial neural network to yield an estimate output of a numerical value related to bone strength, indicating the likelihood of risk of future fracture.

FIG. 1b illustrates a variation of the method of FIG. 1a in which the use of ROIs from multiple exposures is replaced with different, e.g., neighboring ROIs from a single exposure. In step 101, a digital bone image is obtained. Next, in parallel steps 102e, 102f, 102g, and 102h, regions of interest (ROIs) are obtained in the digital bone image obtained in step 101. Again, the image data corresponding to the ROIs may be stored in memory. The ROIs are predetermined areas spaced apart from each other by a distance. For example, the ROIs may be spaced apart a distance of about two widths of a ROI. The remaining steps 103a, 103b, 103c, 103d, 104, 105, and 106 are the same as the corresponding steps described above with reference to FIG. 1a.

FIG. 1c illustrates a modification of the method of FIG. 1b in which the step of averaging the frequency domain data (step 104) is omitted. The remaining steps of FIG. 1c are the same as the steps of FIG. 1b. In step 101, a digital bone image is obtained. Next, in parallel steps 102e, 102f, 102g, and 102h, regions of interest (ROIs) are obtained in the digital bone image obtained in step 101. Again, the image data corresponding to the ROIs may be stored in memory. The ROIs are predetermined areas spaced apart from each other by a distance. For example, the ROIs may be spaced apart a distance of about two widths of a ROI. Next, in parallel steps 103a, 103b, 103c, and 103d, a two-dimensional discrete Fourier transform of the image data in the respective ROIs is calculated. Next, in step 105c, texture feature calculations are performed on the Fourier transformed ROI data. Note that the Fourier transformed ROI data is not averaged in this embodiment. Finally, in step 106, the bone texture feature values computed in step 105c and feature-related data (e.g., bone mass) are merged. Again, merging is performed by classifiers, such as, but not limited to, a linear discriminant and/or an artificial neural network to yield an estimate output of a numerical value related to bone strength, indicating the likelihood of risk of future fracture.

FIG. 1d illustrates a variation of the method of FIG. 1b in which neighboring ROIs from a single exposure are used to compute texture feature values. In step 101, a digital bone image is obtained. Next, in parallel steps 102e, 102f, 102g, and 102h, regions of interest (ROIs) are obtained in the digital bone image obtained in step 101. The ROIs are predetermined areas spaced apart from each other by a distance. For example, the ROIs may be spaced apart a distance of about two widths of a ROI. Next, in parallel steps 107a, 107b, 107c, and 107d, texture feature values are calculated for each set of ROI image data selected in steps 102e, 102f, 102g, and 102h. Note that a Fourier transform is not applied in the method of FIG. 1d. Next, in step 105d, the texture feature values obtained in steps 107a, 107b, 107c, and 107d are averaged. Finally, in step 106, bone texture and feature-related data (e.g., bone mass) are merged. Other feature related data that may be merged with bone texture include bone geometry, bone structure, and clinical data, such as the age of the subject. Merging is performed by classifiers, such as, but not limited to, a linear discriminant and/or an artificial neural network to yield an estimate output of a numerical value related to bone strength, indicating the likelihood of risk of future fracture.

To implement and test the method of the present invention, databases were created for storing the information related to the analysis of bone structure and disease. An exemplary database would contain digital radiographic images obtained, for example, on a commercial portable peripheral bone densitometer for the calcaneus or forearm. In the present study, images of the calcaneus were obtained. The system, comprising a CCD camera with a GdO₂S screen, produces high- and low-energy images in order to perform dual energy subtraction to calculate BMD (bone mineral density). The images were obtained at an exemplary pixel size of 0.2 mm.

A first exemplary database, Database 1, was created with data obtained from thirteen individuals for whom the heel was scanned five times. The exemplary individuals included young, normal volunteers as well as seven osteoporotic patients. Another second exemplary database (Database 2) was created for a second group that included forty-one individuals, for which the heel was scanned twice. Further categorization could be made. For example, the second group might be further categorized into two groups, based upon the presence of a vertebral fracture. In the exemplary data, eleven individuals were identified as having a vertebral fracture and 30 individuals were identified as not having a vertebral fracture. This categorization of vertebral fractures may be used in determining bone strength, since individuals with a vertebral fracture are at a greater risk of getting another fracture, as compared to individuals without a vertebral fracture.

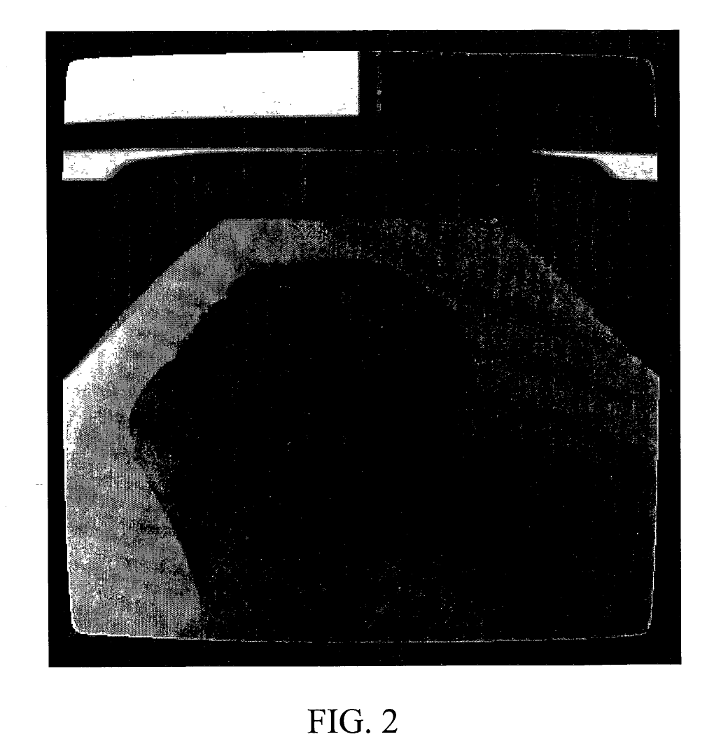

FIG. 2 illustrates an exemplary high-resolution image of the calcaneus. In the acquisition of the image exposures, the heel is not repositioned between scans. Typically, only a slight shift of the heel occurs between scans. In this study, a 64-pixel by 64-pixel ROI was manually selected with the same center pixels the ROI used in a measurement of, e.g., the BMD by the commercial system.

The presence of quantum mottle may limit the use of texture features to adequately quantify bone structure. Thus averaging of image data is commonly used to reduce quantum mottle in images. However, in the analysis of bone trabecular, the averaging of two trabecular pattern ROIs could result in image blur due to a slight shift of the heel between scans. In order to reduce the effect of noise of a trabecular pattern, each ROI is first transformed to spatial frequency space, using, for example, a two-dimensional Fourier transform. Next, in one embodiment, the ROIs are averaged in frequency space, which reduces noise. In addition, calculation errors from image blur from misregistration are also reduced because in the frequency domain, the averaging is of the Fourier components at each relevant (spatial) frequency. Note that the lower frequency components of the trabecular pattern will have a smaller round-off error in the averaging process than will the high-frequency noise components. It should be noted that the Fourier transform of the average of two functions may equal the average of the Fourier transforms of each function; however, this equivalency is only in the situation of no misregistration.

After averaging in the spatial frequency domain, texture features are calculated. For example, one texture feature is the root-mean-square (IRMS):

$$RMS Variation = \frac{\sqrt{\sum m \sum n \vert {F}_{m , n} {\vert}^{2}}}{γ {log}_{10} e}$$

Another texture feature is the first moment of the power spectrum (IFMP):

$$Fist Moment of the Power Spectrum = \frac{\sum m \sum n \sqrt{{m}^{2} + {n}^{2}} \vert {F}_{m , n} {\vert}^{2}}{\sum m \sum n \vert {F}_{m , n} {\vert}^{2}}$$

Note that F_{m,n} refers to the two-dimensional Fourier transform of the two-dimensional ROI image data, with m and n being spatial wavenumbers. Note that for IRMS, γ is a normalizing factor relating the exposure levels of the imaging system and the gray-level (pixel) values. As will be appreciated by those skilled in the art, this factor is included so that the fluctuation between pixel values in the exposure domain can be related to that in the gray level domain. Finally, it should be appreciated that various other appropriate texture features, such as fractal dimension, may also be calculated.

After obtaining the texture features, the texture features are combined with the bone mass density (BMD) measurements using, for example, linear discriminant analysis and/or an artificial neural network (ANN). Receiver operator characteristics (ROC) analysis may be used to evaluate the performance of the new texture feature measurements with the area under the ROC curve (A_{z}) used as a representation of merit in the ability of the feature to distinguish between strong and weak bone.

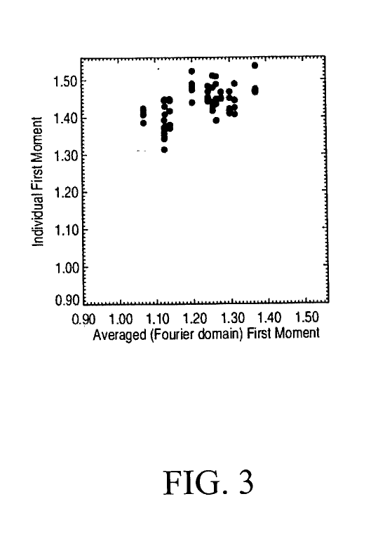

FIG. 3 illustrates that by reducing the high-frequency noise in the image data using averaging, the range of the resulting texture features may be increased. For example, for the first exemplary database described above, the texture feature values of IFMP for the individual images were compared to that for the “frequency-averaged” ROI image data. For the individual ROI analysis, the range of IFMP feature values is from approximately 1.3 to 1.55 cycles/mm, a difference of 0.25 cycles/mm. For the averaged ROI image data, the range of IFMP feature values is approximately 1.05 to 1.4 cycles/mm, a difference of 0.35 cycles/mm.

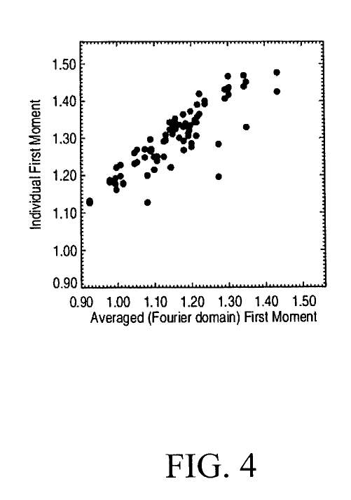

In FIG. 4, for the second exemplary database described above, the texture features of IFMP for the individual images is compared to that for the spatial-frequency-averaged ROI image data for the individual images. For the ROI analysis for individual images, the exemplary range of IFMP feature values is from approximately 1.13 to 1.48 cycles/mm, a difference of 0.35 cycles/mm. For the averaged ROI data, the range of IFMP feature values is approximately 0.92 to 1.43 cycles/mm, a difference of 0.51 cycles/mm, a. Therefore, FIGS. 3 and 4 illustrate that the range of IFMP values became larger for the average ROI data, as compared to the ROI analysis of individual images.

The improvement, i.e., the increased range of IFMP values for the averaged ROI data, results in an enhanced ability to distinguish between “strong” and “weak” bone, as shown in Tables 1 and 2, which provide individual ROI A₂ values and averaged ROI A_{z} values for both individual features and merged features. Tables 1 and 2 indicate that an averaging of the multiple ROIs in the frequency domain reduced the contribution of quantum mottle as well as computer round-off error to the calculation of the texture features. Averaging also increased the range of texture feature values and improved the texture feature values performance in distinguishing between strong and weak bone. Avergaing may be especially necessary in the low-dose setting of screening protocols. It should be appreciated that if multiple exposures are not obtained, multiple ROIs in the spatial frequency domain and from the same exposure may be averaged, as in the method illustrated in FIG. 1b. The utility of this approach assumes that the trabecular pattern does not vary greatly across a given region of the heel.

Once the texture feature(s) and/or merged features are obtained, the data may be presented numerically, e.g., in terms of the first moment of the power spectrum, or visually, in terms of a feature image in which the texture feature is calculated at each pixel location in the image. The calculation of the texture features may be done for either multiple images or one image since the ROI may be placed at each pixel location in the image and the texture measure calculated at each location.

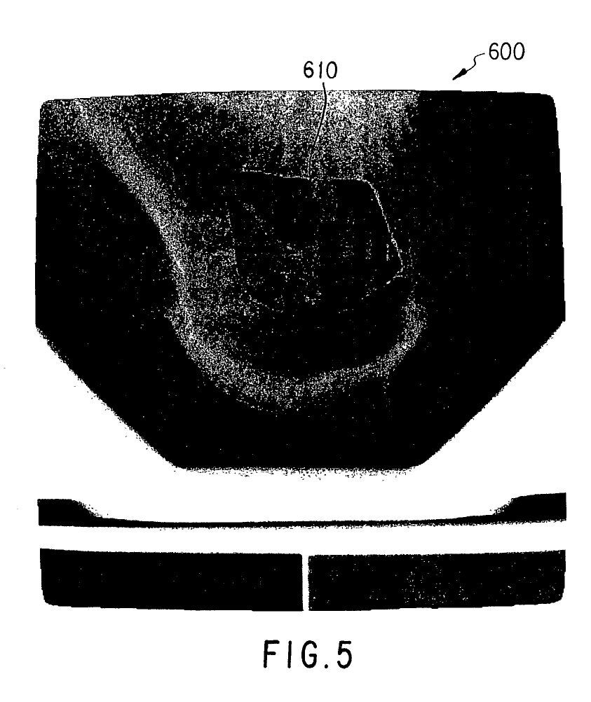

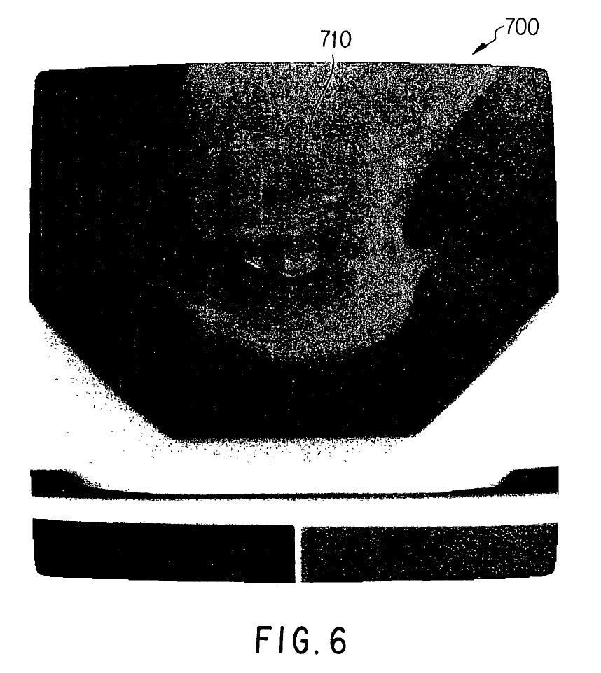

FIGS. 5 and 6 illustrate examples of IFMP feature images. FIG. 5 illustrates an IFMP feature image 600 for an individual with a spine fracture. The color scale indicates high values of the IFMP near green/blue region 610. FIG. 6 illustrates an IFMP feature image 700 for an individual without a spine fracture. The color scale indicates low values of the IFMP near the green/yellow/red region 710. The feature image also indicates a consistency of the trabecular pattern throughout the heel bone. Also illustrated is the result of the use of averaging neighboring ROIs in the spatial frequency domain to reduce the noise effect, since the variation across the image is relatively small.

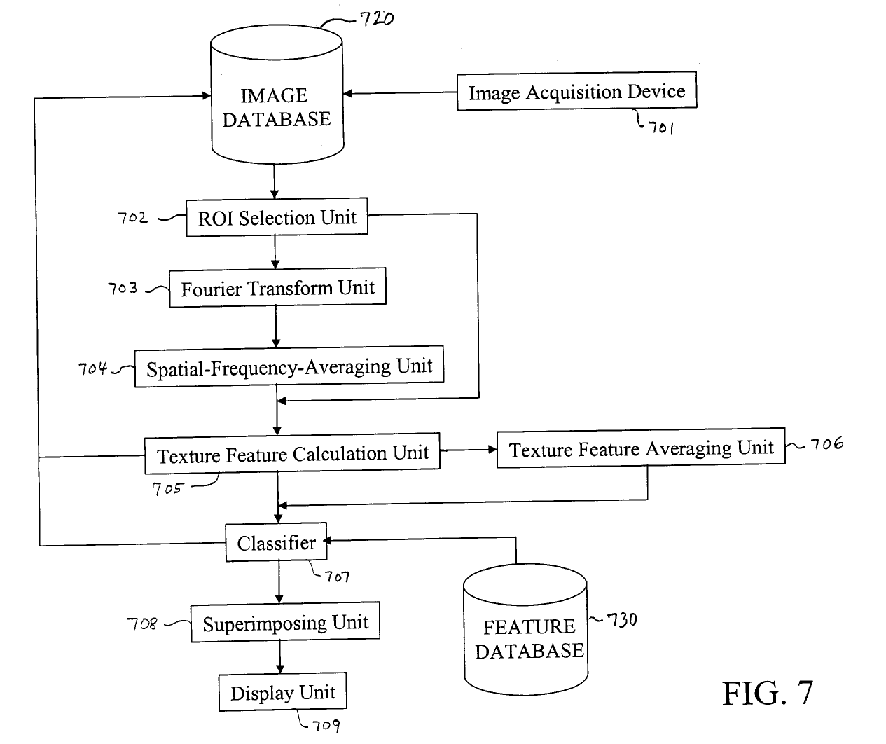

FIG. 7 illustrates a system for implementing the method of the present invention for analysis of the bone trabecular structure. Radiographic images of a bone (or other types of images) may be obtained from an Image Acquisition Device 701 and stored in Image Database 720. Also, it should be appreciated that the source of data may be any appropriate image acquisition device such as an X-ray machine, CT apparatus, or MRI apparatus, for example. Moreover, the Image Database 720 may be located locally or in a remote location, in which case a data communication network, such as PACS (Picture Archiving Computer System), can be used to access the image data at an appropriate time for processing according to the present invention. The radiographic image(s) may be digitized to produce digitized image(s) and stored in Image Database 720 for subsequent retrieval and processing, as may be desired by a user. However, it should be appreciated that if the radiographic image is obtained with a direct digital imaging device, then there is no need for digitization. Further, it should be appreciated that only a single image might be obtained. Note further that the system of FIG. 7 is typically computer implemented, but conceptually can be implemented by discrete circuits or other appropriate devices.

Image data from the Image Database 720 is first passed through the ROI Selection Unit 702, which selects at least one ROI from the image data. The Fourier Transform Unit 703, or another appropriate spatial frequency domain transforming device may receive the image data related to each of the ROIs and transforms the image data into the (spatial) frequency domain. The Spatial-Frequency-Averaging Unit 704 then averages the transformed data. In determining bone structure, the transformed spatial-frequency-averaged data is passed from Spatial-Frequency-Averaging Unit 704 to the Texture Feature Calculation Unit 705, which calculates texture feature values. Note that, in some embodiments, the ROI image data may be passed directly to the Texture Feature Calculation Unit 705. The output of the Texture Feature Calculation Unit 705 for multiple ROIs may also be averaged by the Texture Feature Averaging Unit 706. Other feature related data stored in the Feature Database 730, which may include measures of bone mass, bone structure, and/or patient data, may be then passed to the Classifier 707, where it is merged with the texture feature values passed from either the Texture Feature Calculation Unit 705 or the Texture Feature Averaging Unit 706. The Classifier 707 determines an estimate of bone strength, and thus the likelihood for risk of future fracture. Any and all of the texture features and merged data may be stored in the Image Database 720. In the Superimposing Unit 708, the texture feature values and/or merged data are presented as feature images and stored in an appropriate file format or in numerical format. The texture features and/or merged data may be then displayed using a Display Unit 709, after passing through a digital-to-analog converter (not shown) or any other appropriate processing device.

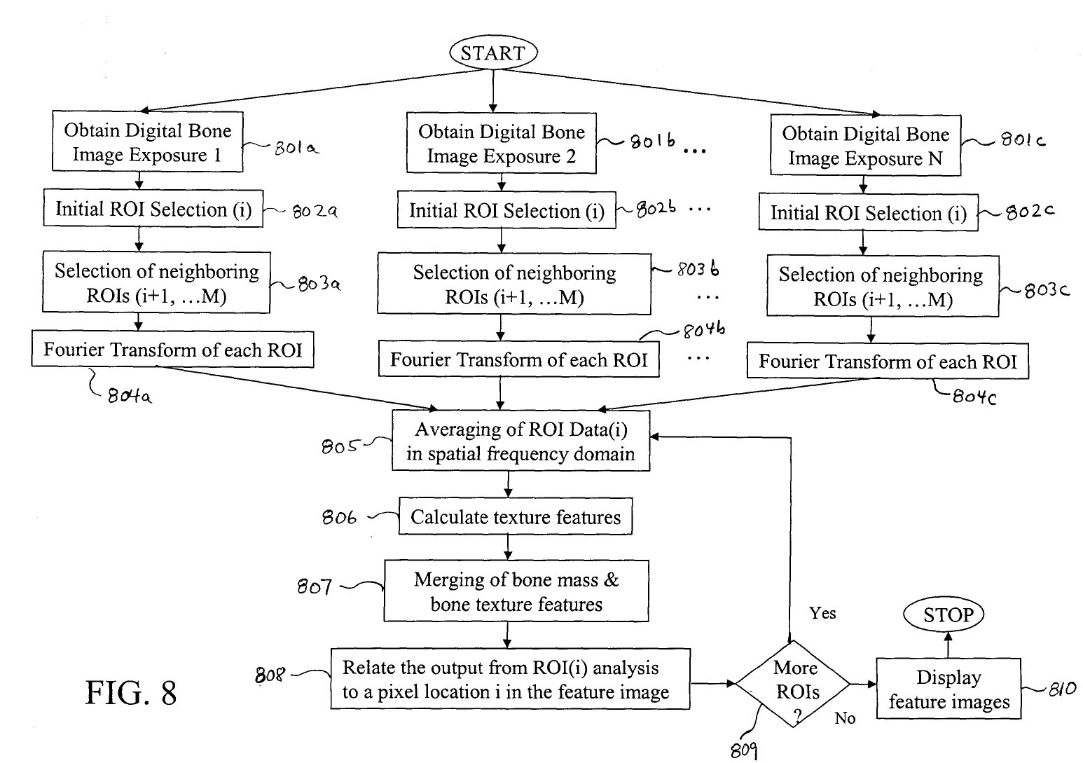

FIG. 8 illustrates the calculation and display of a texture feature image using multiple exposures. In parallel steps 801a, 801b, and 801c N digital bone images are obtained. Initial ROI selection is completed in parallel steps 802a, 802b, and 802c. Selection of neighboring or adjacent ROIs of the heel region (for example) of the images with the center of each ROI corresponding to a pixel location in the ultimate feature image is performed in parallel steps 803a, 803b, and 803c. A feature image may be created from multiple exposures, and therefore noise reduction is performed. In parallel steps 804a, 804b, and 804c, a two-dimensional Fourier transform (or other appropriate transform into the spatial frequency domain) is applied to each ROI selection (e.g., 1 to M) of the N images. Accordingly, the ROI data is transformed to the spatial frequency space.

In step 805, the corresponding ROI(i) data from each of the N image data sets is averaged. For example, the ROIs(1) from each of the N images are averaged. In step 806, at at least one texture feature calculation is performed for the averaged ROI(i) data. In step 807, bone texture features are merged with bone mass or other appropriate bone-related data. In step 808, the output from the ROI(i) analysis is related to a pixel location i in each of the feature images. Next, in step 809, an inquiry is made whether all M ROIs have been processed. If not, steps 805-809 are repeated. If the answer to the inquiry is yes, the feature images are displayed in step 810.

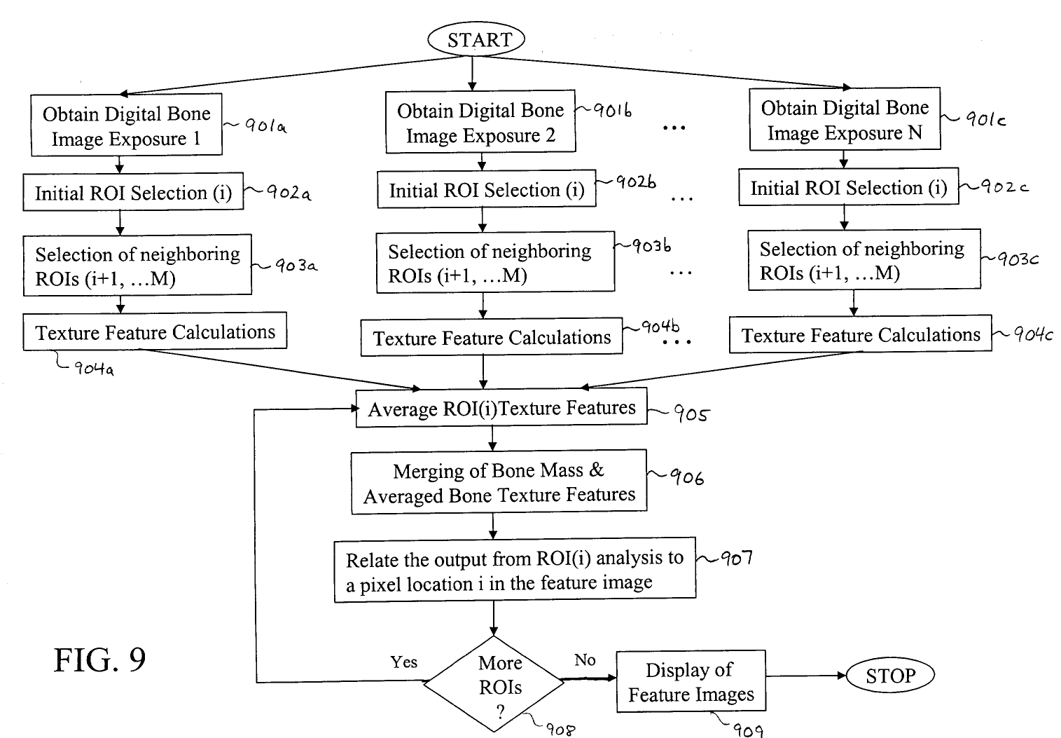

FIG. 9 illustrates a second embodiment of the the calculation and display of a texture feature image using multiple exposures. In parallel steps 901a, 901b, and 901c N digital bone images are obtained. Initial ROI selection is completed in parallel steps 902a, 902b, and 902c. Selection of neighboring or adjacent ROIs of the heel region (for example) of the images with the center of each ROI corresponding to a pixel location in the ultimate feature image is performed in parallel steps 903a, 903b, and 903c. A feature image may be created from multiple exposures, and therefore noise reduction is performed. In parallel steps 904a, 904b, and 904c, texture features are calculated for each ROI selection (e.g., 1 to M) of the N images.

In step 905, the corresponding ROI(i) data from each of the N image data sets is averaged. For example, the ROIs(1) from each of the N images are averaged. In step 906, bone texture features are merged with bone mass or other appropriate bone-related data. In step 907, the output from the ROI(i) analysis is related to a pixel location i in each of the feature images. Next, in step 908, an inquiry is made whether all M ROIs have been processed. If not, steps 905-908 are repeated. If the answer to the inquiry is yes, the feature images are displayed in step 909.

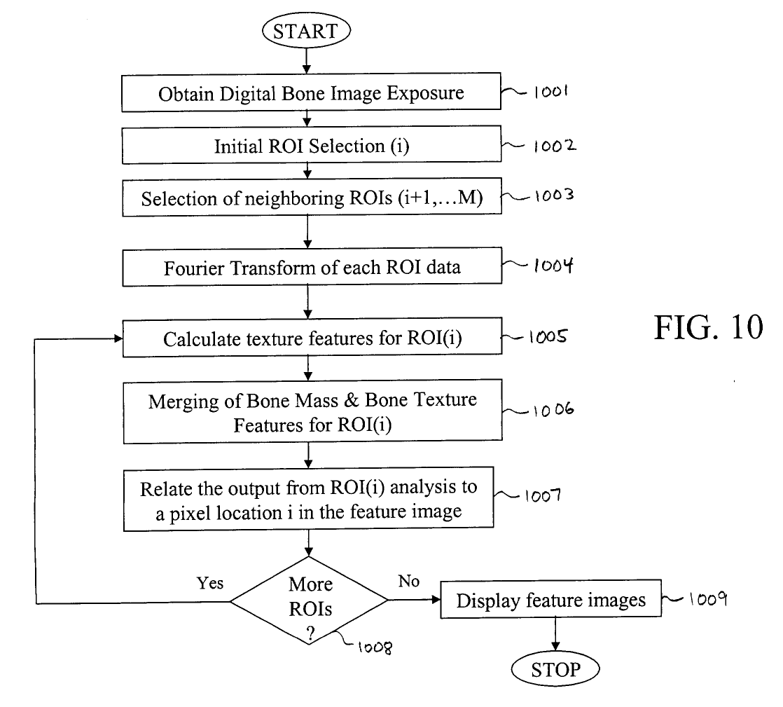

FIG. 10 illustrates calculation and display of the feature images for a single image exposure is shown. In step 1001, a digital bone exposure image is obtained. Next, initial ROI section of ROI(i) is performed in step 1002. In step 1003, neighboring or adjacent ROIs (i+1 to M) are selected. An exemplary exposure image may be a heel region with the center of each ROI corresponding to a pixel location in the ultimate feature image. In step 1004 a two-dimensional Fourier transform (or other appropriate transform into the spatial frequency domain) is applied to each ROI selection.

In step 1005, at least one texture feature calculation is performed for ROI(i). In step 1006, bone texture features are merged with bone mass or other appropriate bone-related data. In step 1007, the output from the ROI(i) analysis is related to a pixel location i in each of the feature images. Next, in step 1008, an inquiry is made whether all M ROIs have been processed. If not, steps 1005-1008 are repeated. If the answer to the inquiry is yes, the feature images are displayed in step 1009.

The source of image data may be any appropriate image acquisition device such as an X-ray machine, CT apparatus, and MRI apparatus. Further, the acquired data may be digitized if not already in digital form. Alternatively, the source of image data being obtained and processed may be a memory storing data produced by an image acquisition device, and the memory may be local or remote, in which case a data communication network, such as PACS (Picture Archiving Computer System), can be used to access the image data for processing according to the present invention.

This invention conveniently may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

As disclosed in cross-referenced U.S. patent application Ser. No. 09/818,831, a computer implements the method of the present invention, wherein the computer housing houses a motherboard which contains a CPU, memory (e.g., DRAM, ROM, EPROM, EEPROM, SRAM, SDRAM, and Flash RAM), and other optional special purpose logic devices (e.g., ASICS) or configurable logic devices (e.g., GAL and reprogrammable FPGA). The computer also includes plural input devices, (e.g., keyboard and mouse), and a display card for controlling a monitor. Additionally, the computer may include a floppy disk drive; other removable media devices (e.g. compact disc, tape, and removable magneto-optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus.

As stated above, the system includes at least one computer readable medium. Examples of computer readable media are compact discs, hard disks, floppy disks, tape, magneto-optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications, such as development tools. Computer program products of the present invention include any computer readable medium which stores computer program instructions (e.g., computer code devices) which when executed by a computer causes the computer to perform the method of the present invention. The computer code devices of the present invention can be any interpretable or executable code mechanism, including but not limited to, scripts, interpreters, dynamic link libraries, Java classes, and complete executable programs. Moreover, parts of the processing of the present invention may be distributed (e.g., between (1) multiple CPUs or (2) at least one CPU and at least one configurable logic device) for better performance, reliability, and/or cost. For example, an outline or image may be selected on a first computer and sent to a second computer for remote diagnosis.

The invention may also be implemented by the preparation of application specific integrated circuits or by interconnecting an appropriate network of conventional component circuits, as will be readily apparent to those skilled in the art.

Numerous modifications and variations of the present invention are possible in light of the above technique. It is therefore to be understood that within the scope of the appended claims, the invention may be practiced otherwise than as specifically described herein.

TABLE 1
Performance of Features in Distinguishing
between Strong & Weak Bone; Database 1

| Feature | Single ROI (Az) | Averaged ROI Data (Az) |
|---|---|---|
| IRMS | 0.624 | 0.673 |
| IFMP | 0.696 | 0.751 |

TABLE 2
Performance of Features in Distinguishing between Strong & Weak
Bone; Database 2; (ROI A_{z} value of BMD = 0.529)

| Feature | Single ROI (Az) | Averaged ROI Data (Az) |
|---|---|---|
| IRMS | 0.504 | 0.570 |
| IFMP | 0.506 | 0.576 |
| IFMP, BMD | 0.516 | 0.576 |
| IRMS, IFMP, | 0.531 | 0.584 |
| BMD | | |

What is claimed as new and desired to be secured by Letters Patent of the United States is:

1. A method of analyzing a medical image to determine a measure of bone strength, comprising:
identifying plural regions of interest (ROIs) in the medical image;
calculating at least one texture feature value for each ROI;
averaging the at least one texture feature value calculated for each ROI to obtain at least one average texture feature value; and
determining the measure of bone strength based on the at least one average texture feature value.

2. The method of claim 1, wherein the calculating step comprises:
calculating as the at least one texture feature value, at least one of a root-mean-square value, a first moment of a power spectrum value, and a Minkowski dimension.

3. The method of claim 1, wherein the determining step comprises:
determining the measure of bone strength by merging the at least one texture feature with feature-related data using a classifier,
said feature-related data including at least one of bone geometry, bone structure, bone mass data, and clinical data.

4. The method of claim 3, wherein the determining step comprises:
determining the measure of bone strength by merging the at least one texture feature with feature-related data using at least one of an artificial neural network and a linear discriminant.

5. A method of analyzing a medical image to determine a measure of bone strength, comprising:
identifying plural regions of interest (ROIs) in the medical image;
transforming image data in each of said ROIs into respective frequency domain image data;
averaging the respective frequency domain image data to obtain average image data;
calculating at least one texture feature value from the average image data; and
determining the measure of bone strength based on the at least one texture feature value.

6. The method of claim 5, wherein the transforming step comprises:
transforming image data in each of said ROIs into the respective frequency domain image data using a two-dimensional Fourier transform.

7. The method of claim 5, wherein the calculating step comprises:
calculating as the at least one texture feature value, at least one of a root-mean-square value, a first moment of a power spectrum value, and a Minkowski dimension.

8. The method of claim 5, wherein the determining step comprises:
determining the measure of bone strength by merging the at least one texture feature with feature-related data using a classifier,
said feature-related data including at least one of bone geometry, bone structure, bone mass data, and clinical data.

9. The method of claim 8, wherein the determining step comprises:
determining the measure of bone strength by merging the at least one texture feature with feature-related data using at least one of an artificial neural network and a linear discriminant.

10. A method of analyzing plural medical images to determine a measure of bone strength, comprising:
identifying a region of interest (ROI) having a corresponding center pixel in each medical image;
transforming image data in the ROI of each medical image into respective frequency domain image data;
averaging the respective frequency domain image data to obtain average image data;
calculating at least one texture feature value from the average image data; and
determining the measure of bone strength based on the at least one texture feature value.

11. The method of claim 10, wherein the transforming step comprises:
transforming image data in each of said ROIs into the respective frequency domain image data using a two-dimensional Fourier transform.

12. The method of claim 10, wherein the calculating step comprises:
calculating as the at least one texture feature value, at least one of a root mean square value, a first moment of a power spectrum value, and a Minkowski dimension.

13. The method of claim 10, wherein the determining step comprises:
determining the measure of bone strength by merging the at least one texture feature with feature-related data using a classifier,
said feature-related data including at least one of bone geometry, bone structure, bone mass data, and clinical data.

14. The method of claim 13, wherein the determining step comprises:
determining the measure of bone strength by merging the at least one texture feature with feature-related data using at least one of an artificial neural network and a linear discriminant.

15. The method of claim 10, further comprising:
repeating the identifying, transforming, averaging, and calculating steps for a plurality of ROIs having a corresponding plurality of center pixels;
associating the at least one feature value calculated in each calculating step with a center pixel in the corresponding plurality of center pixels to form at least one texture feature image.

16. The method of claim 15, further comprising:
displaying each of the at least one texture feature image as a color image on a display unit.

17. A method of analyzing a medical image to determine a measure of bone strength, comprising:
identifying plural regions of interest (ROIs) in the medical image, each ROI having a corresponding center pixel;
transforming image data in each of said ROIs into respective frequency domain image data;
calculating at least one texture feature value for each ROI using the respective frequency domain image data; and
determining the measure of bone strength based on the at least one texture feature value.

18. The method of claim 17, further comprising:
repeating the identifying, transforming, and calculating steps for a plurality of ROIs having a corresponding plurality of center pixels; and
associating the at least one feature value calculated for each ROI with the corresponding center pixel to form at least one texture feature image.

19. A method of analyzing plural medical images to form at least one texture feature image, comprising:
identifying a region of interest (ROI) having a corresponding center pixel in each medical image;
calculating at least one texture feature value for the ROI in each medical image;
averaging the at least one texture feature value of each medical image in the plural medical images;
repeating the identifying, calculating, and averaging steps for a plurality of ROIs having a corresponding plurality of center pixels;
associating the at least one feature value calculated in each calculating step with a center pixel in the corresponding plurality of center pixels to form the at least one texture feature image.

20. A computer program product storing program instructions for execution on a computer system, which when executed by the computer system, cause the computer system to perform the method recited in any one of claims 1-19.

21. A system configured to analyze a medical image by performing the steps recited in any one of claims 1-19.
